(19) United States
(12) Patent Application Publication
(10) Pub. No.: US 2006/0077265 A1
(43) Pub. Date: Apr. 13, 2006

(54) Picture management method, picture management apparatus, picture management system

(76) Inventors: Tetsuya Matsumoto, Yokohama (JP); Keiji Nagayama, Yokohama (JP); Akinobu Ishizuka, Yokohama (JP); Hiroshi Kawano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/188,733

(22) Filed: Jul. 26, 2005

(30) Foreign Application Priority Data
Sep. 27, 2004 (JP) JP2004-278654

(51) Int. Cl. H04N 5/76

(52) U.S. Cl. 348/231.99; 348/231.5

(57) ABSTRACT

An image management method of recording image data, together with date information indicative of a recording date at a predetermined recording medium to manage the image data in day-by-day groups based on the date information of the image data, has the step of detecting an image source of image data to be recorded. When image data from a first image source and image data from a second image source are recorded on the same day, the image data from the first image source is managed in a first group based on the date information, while the image data from the second image source is managed in a new second group.

### INCORPORATION BY REFERENCE

The present application claims priority from Japanese application JP2004-278654 filed on Sep. 27, 2004, the content of which is hereby incorporated by reference into this application.

### BACKGROUND

The present invention relates to a method, apparatus, and system for managing image data captured from an image pickup device and the like.

In recent years, with the advancement of the recording medium and recording technologies, an ever increasing amount of data can be recorded on a recording medium which therefore records an increasing number of image data. As such, the user is required to expend enormous efforts when the user attempts to search a recording medium for desired image data. Particularly, with a video camera, the user often shoots and records pictures frequently for a short time at every occasion, so that if captured image data are to be managed in groups on a shot-by-shot basis, the image data will be managed in an immense number of groups. Thus, recorded image data must be arranged for management to facilitate a search for desired image data from a recording medium.

In the prior art, an image pickup device has been proposed for managing images shot and recorded by a digital camera in groups according to recorded data for taking into account the ease of search (see, for example, JP-A-2001-54041).

On the other hand, analog images recorded on recording media such as video tapes in the past are dubbed to recording media such as DVD discs to leave the images in the form of digital image data. In this event, image data is recorded on a DVD disc or the like with the date at which the image data is dubbed, thus making it impossible to know when the image data was recorded in the past. Thus, it has been required to record image data together with a past date at which the image data was originally shot when the image data is dubbed.

In the prior art, an editing system has been proposed for allowing the user to change date information when image data is dubbed. Specifically, the editing system extracts date information from reproduced image data for transfer to a recorder, so that the extracted date information is recorded together with the image data. In addition, this editing system permits the user to manually enter date information through a keyboard from the outside when date information cannot be extracted from image data which is to be dubbed (see, for example, JP-A-6-36523).

Further, another prior art method has been proposed for dubbing between digital image data. Specifically, date information is extracted from original digital image data, and the extracted date information is added to digital image data which is recorded by dubbing. In this way, the digital image data can be recorded together with the date at which the digital image data was originally recorded (see, for example, JP-A-2001-94921).

### SUMMARY

Recent image pickup devices not only record current image data but dubs image data shot and recorded in the past on a DVD disc using an external input terminal. This results in an increase in opportunities of recording current image data from an image pickup device and dubbing past image data from an external input terminal on the same day. In this event, since image data from the image pickup device is hardly related to image data from the external input terminal, they are desirably managed in different groups.

However, JP-A-2001-54041 does not take into consideration sources of image data. The prior art techniques described in JP-A-6-36523 and JP-A-2001-94921 do not give consideration to the management of image data according to groups.

In view of the foregoing, it is an object of the present invention to provide an image management method and system which are capable of facilitating a search for image data from an image pickup device and dubbed image data.

The present invention provides a recording apparatus for receiving image data from a plurality of image sources to record the image data together with date information associated with the image data. The apparatus includes a detector module which detects the image source, and a current date information holder module which holds current date information, wherein the recording apparatus, based on a detection made by the detector module, corresponds date information from the current date information holder module to image data from a first image source, and corresponds date information different from the date information from the current date information holder module to image data from a second image source.

The present invention can facilitate a search for image data and consequently improve the usability.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating a camera integrated recorder according to one embodiment of the present invention;

FIGS. 2A, 2B, 2C are conceptual diagrams each showing recording data recorded by the camera integrated recorder 100;

FIG. 3 is a flow chart illustrating a processing procedure of recording in an external input mode according to one embodiment of the present invention;

FIG. 4 is a flow chart illustrating a processing procedure of recording in a camera input mode according to one embodiment of the present invention; and

FIG. 5 is a diagram for describing an exemplary screen displayed on a display unit for prompting the user to enter the date.

### DETAILED DESCRIPTION OF THE EMBODIMENTS

In the following, one embodiment of the present invention will be described in detail with reference to the accompanying drawings.

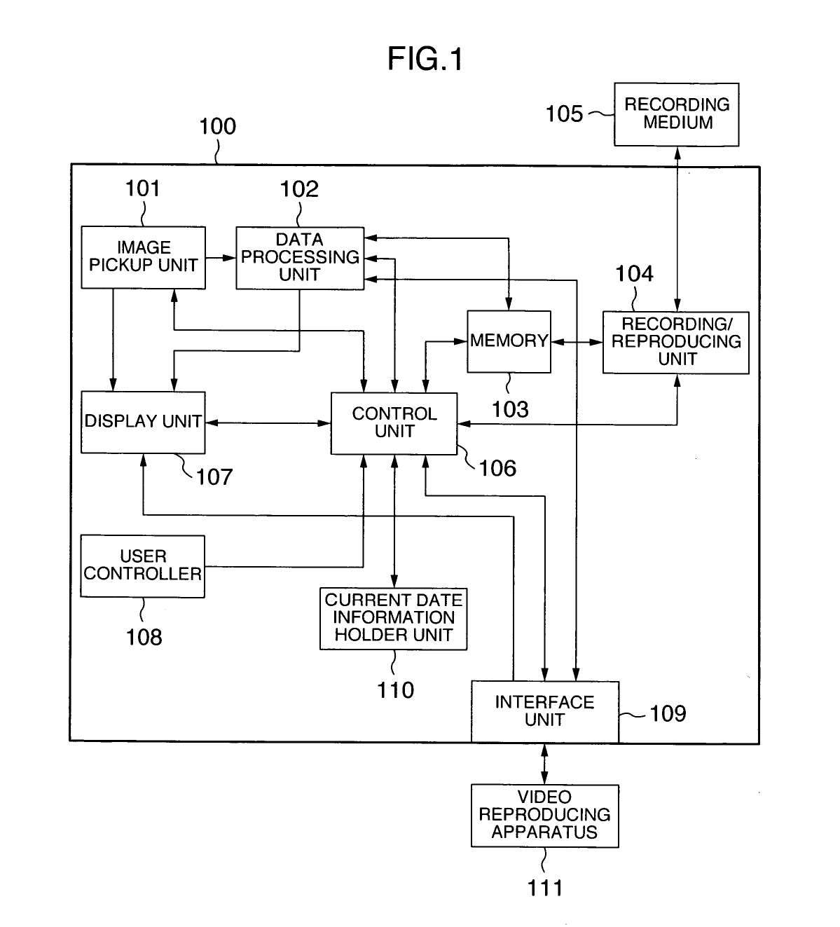

FIG. 1 is a block diagram illustrating a camera integrated recorder (hereinafter simply called the “video camera”) according to one embodiment of the present invention. Referring to FIG. 1, a general description will be given of the operation of the video camera and the flow of signals. While this embodiment employs a compression encoding format conforming to the MPEG (Moving Picture Experts Group) standard, the format is not limited to this standard but any other format may be used in this embodiment.

In FIG. 1, a video camera 100 processes and compresses a captured moving image or still image and digitally records the processed and compressed image. The video camera 100 comprises an image pickup unit 101 which includes a lens, a CCD (Charge-Coupled Device), and an image processing circuit for generating a predetermined video signal from an optical image from a subject. An input from the image pickup unit 101 is referred to as a camera input. A data processing unit 102 digitizes a video signal generated by the image pickup unit 101 and sent thereto, compress-encodes the resulting digital video signal in accordance with the MPEG standard to generate image data, and decodes a reproduced signal from a recording medium. A memory 103 temporarily stores image data from the data processing unit 102. A recording/reproducing unit 104 records image data sent from the memory 103 on a recording medium 105, and reads a reproduced signal from the recording medium 105. The recording medium 105 records image data. A control unit 106 controls the overall video camera 100 and respective components thereof. A display unit 107 displays a video image captured by the image pickup unit 101, a video image reproduced by the recording/reproducing unit 104, and a video image and a variety of information entered from an external device. A user controller 108 is operated by the user to enter instructions. An interface unit (external input terminal) 109 supplies a video signal inputted from an external device such as a video reproducing apparatus 111 to the data processing unit 102 and display unit 107. In this embodiment, an image signal inputted through the interface unit 109 is called the “external input.” A current date and time information holder unit 110 holds the current date and time within the video camera 100. The external device 111 may be a video reproducing apparatus for reproducing a video image.

There are two input modes available for the video camera 100: the camera input mode and external input mode, as mentioned above. As the input mode is switched through the user controller 108, the instruction is transferred to the control unit 106 which controls the image pickup unit 101 and interface unit 109 to send a video signal from the image pickup unit 101 to the data processing unit 102 and display unit 107 in the camera input mode, and to send a video signal from the interface unit 109 to the data processing unit 102 and display unit 107 in the external input mode. In the camera input mode, a video signal from the image pickup unit 101 is sent from the image pickup unit 101 to the data processing unit 102 which converts the video signal to digital image data and compress-encodes the digital image data in accordance with the MPEG standard. The resulting image data is sent to the recording/reproducing unit 104 through the memory 103, and is recorded on the recording medium 105 by the recording/reproducing unit 104. In the external input mode, in turn, the external input mode is indicated from the user controller 108, so that the control unit 106 determines the external input mode. A video signal inputted from the interface unit 109 is sent to the data processing unit 102 which converts the video signal to digital image data and compresses the digital image data in accordance with the MPEG standard. The resulting image data is sent to the recording/reproducing unit 104 through the memory 103, and is recorded on the recording medium 105 by the recording/reproducing unit 104.

Next, a description will be given of the general operation of an image management method according to this embodiment. In this embodiment, a set of recorded image data is designated a scene, and scenes are grouped into a program. Which scene is included in which program is managed by program range information included in management information recorded on the recording medium 105 under the control of the control unit 106.

When recording is started, the control unit 106 first determines whether or not the video camera 100 is set in the camera input mode or external input mode. When the video camera 100 is set in the camera input mode, a current date held in the current date and time information holder unit 110 is sent to the control unit 106. The control unit 106 also reads date information associated with respective image data recorded on the recording medium 105 through the recording/reproducing unit 104. The control unit 106 compares the current date held in the current date and time information holder unit 110 with the dates associated with the image data recorded on the recording medium 105 to find the same date. If the same date is found, the control unit 106 modifies the program range information within the management information such that the image data recorded from the image pickup unit 101 belongs to the same group as the image data (scene) previously recorded on the recording medium 105, and records the image data and date information on the recorded image data. In this way, the recorded image data can be included in the same date group as scenes previously recorded on the recording medium 105. Conversely, if the same date is not found, the control unit 106 newly adds and records a program and program range information within the management information such that the image data to be recorded from the image pickup unit 101 belongs to a new group different from those scenes previously recorded on the recording medium 105, and records the image data and date information associated with the recorded image data. In this way, the recorded image data can be included in a different date group from the scenes previously recorded on the recording medium 105.

When the video camera 100 is set in the external input mode, the control unit 106 newly adds and records a program and program range information within the management information such that image data to be recorded from the interface unit 109 belongs to a new different group from those scenes previously recorded on the recording medium 105, starts recording the image data, and displays a date information entry guidance on the display unit 107. In accordance with the displayed guidance, the user enters the date through the user controller 108, so that the date is recorded together with the image data as date information.

This method permits image data recorded in the external input mode to belong to a different group from image data recorded in the camera input mode, so that a dubbed image, even recorded on the same date, is included in a different group from an image captured by the video camera 100, thus facilitating a search for image data. Further, since the date information entry guidance for the user to enter date information is automatically displayed on the display unit 107 upon recording from the external input, the user will not forget to enter the date information. Since the user can enter the date information in accordance with the displayed guidance to modify the date information with high operability, the user can also search for a desired image data with ease.

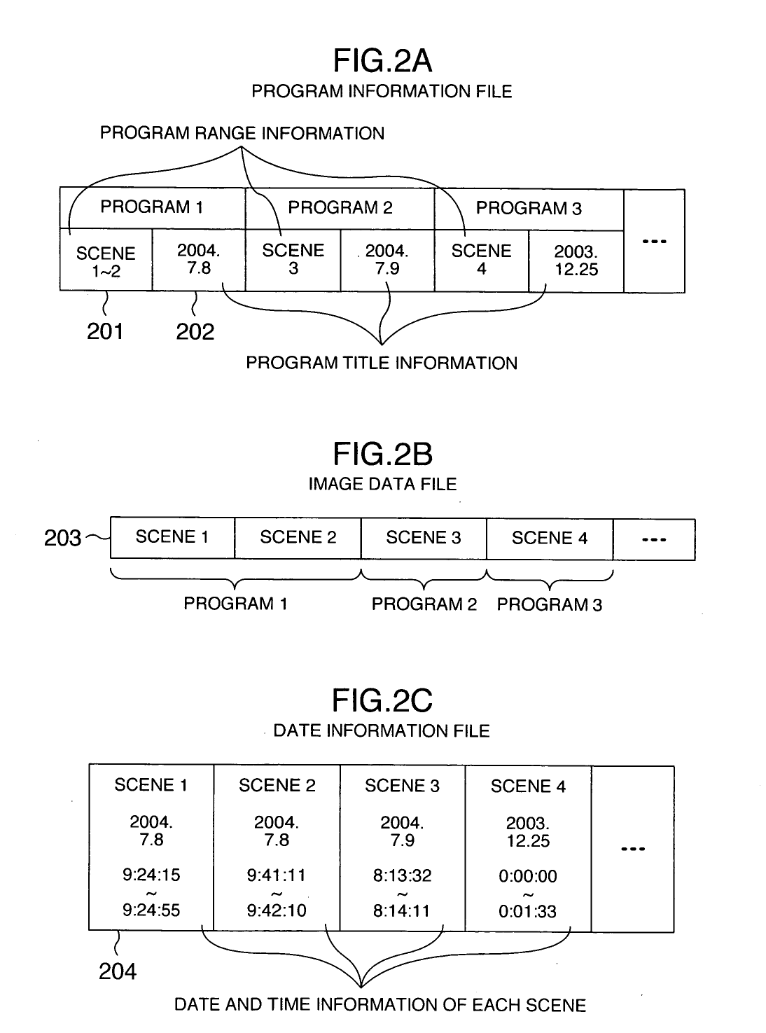

Referring next to FIGS. 2A, 2B, 2C, a description will be given of the structure of recording data when image data is captured, compress-encoded, and recorded on the recording medium 105 by the video camera 100 in accordance with this embodiment. The recording data refers to a set of data which includes, other than image data, management information indicative of how the recorded image data is managed in which group, and date and time information associated with the recorded image data.

As shown in FIGS. 2A, 2B, 2C, there are three types of files for the recording data, which are recorded in relation to one another. A program information file shown in FIG. 2A contains management information which includes information 201 indicative of a range of a group of scenes which are treated as one program, and program title information 202. Here, the term “scene” refers to image data which is recorded from the start of recording to the end of recording at one time. An image data file shown in FIG. 2B contains scenes in an order in which they were recorded. A date and time information file shown in FIG. 2C in turn contains date and time information of each scene.

Next, a description will be given of a data configuration generating operation when the video camera of this embodiment is used. First, when a blank recording medium is newly recorded in the camera input mode, a scene 1 is recorded in the image data file 203. Here, the program range information 201 stores information indicating that the scene 1 belongs to a program 1, and a program title information 201 stores the date (Jul. 8, 2004) on which the scene 1 was recorded in the form of a character string which serves as a title for the program 1. The date information 204 of each scene contains the date (Jul. 8, 2004) and time information (9:24:15-9:24:55) in which the recording of the scene 1 was started, such that the date and time information is associated with the scene 1. Next, if an image (scene 2) is recorded once again in the camera input mode on the same day the scene 1 was recorded, the scene 2 is recorded in the image data file 203 because it is recorded at the same date, the program range information 201 contains information indicating that the program 1 includes the scene 1 and scene 2, and the date information 204 of each scene contains the date and time information (Jul. 8, 2004, 9:41:11-9:42:10), which indicates when the scene 2 was recorded, such that the date and time information is associated with the scene 2.

Next, as a scene 3 is recorded in the camera input mode on a different day from the day on which the scenes 1, 2 were recorded, the scene 3 is recorded in the image data file 203, the program range information 201 additionally contains information indicating that the scene 3 belongs to a program 2, and the program title information 202 contains the date (Jul. 9, 2004) on which the recording of the scene 3 was started in the form of a character string which serves as title information of the program 2. Also, the date and time information 204 of each scene contains date and time information (Jul. 9, 2004, 8:13:32-8:14:11) indicating when the scene 3 was recorded, such that the date and time information 204 is associated with the scene 3.

Next, as a scene 4 is recorded in the external input mode on the same day the scene 3 is recorded, the scene 4 is recorded in the image data file 203, and the program range information 201 additionally contains information indicating that the scene 4 belongs to the program 3 irrespective of whether the scene 4 is recorded on the same date as or a different date from the date at which the scene 3 was recorded. The program title information 202 contains a date (Dec. 25, 2005) entered by the user in the form of a character string which serves as title information for the program 3. Also, the date and time information 204 of each scene contains date information (Dec. 25, 2003) entered by the user, and time information of the scene 4 which is automatically recorded from at 00:00:00 and terminated at 0:01:33 (0:00:00-0;01:33), such that the date and time information is associated with the scene 4. In the foregoing operation, the user may enter not only the date information but also time information indicting the time at which the recording was started.

In this way, image data recorded in the external input mode belongs to a different group from image data recorded in the camera input mode, so that a dubbed image belongs to a different group from a group of images captured by the video camera 100, thus facilitating a search for image data. Specifically, through predetermined operations on the user controller 108, the user can display a list of date information based on the program name and thee information 202 on the display unit 107. Thus, the user references the program title information on the display unit 107 to know the date at which his desired scene in the program was actually recorded, and can rapidly search for a desired scene for viewing.

Next, a description will be given of a processing procedure of an image data management method according to this embodiment.

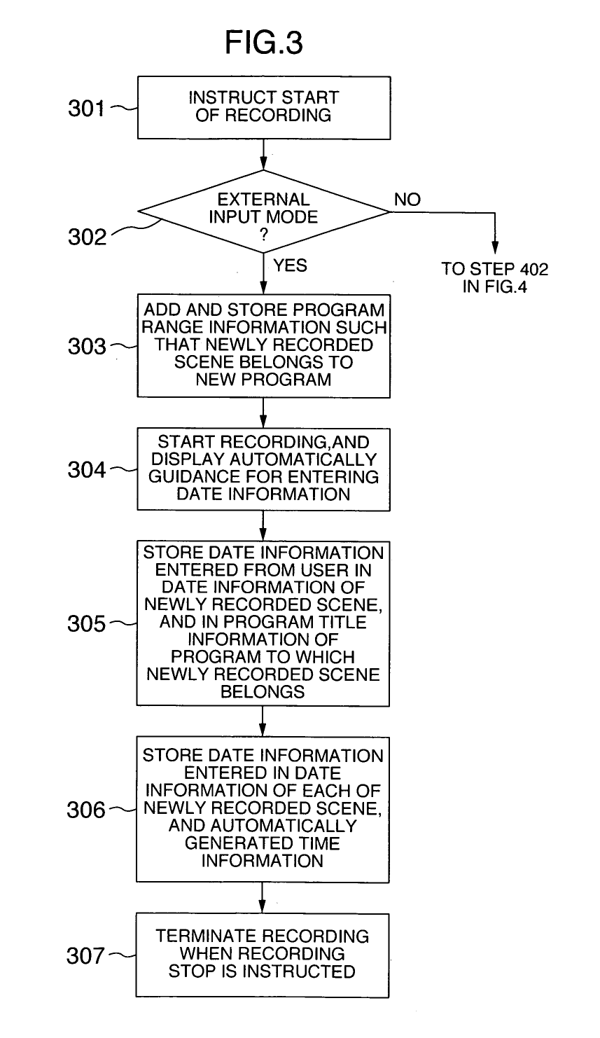

FIG. 3 illustrates an exemplary flow chart of a recording processing procedure in the external input mode according to this embodiment for describing the flow of processing.

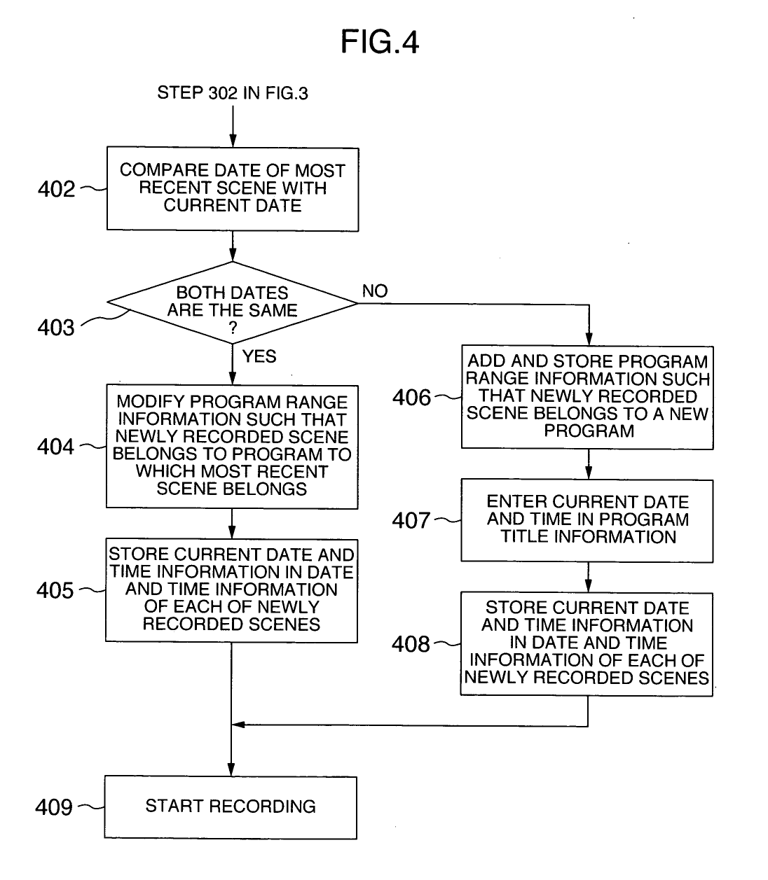

At step 301, after the user has operated on the user controller 108 to issue a recording start instruction, the control unit 106 determines at step 302 whether or not the video camera 100 is currently in the camera input mode or external input mode. When in the camera input mode, the flow proceeds to step 402 in FIG. 4, and subsequently, recording is started in accordance with a processing procedure, described later with reference to FIG. 4. When in the external input mode at step 302, the program range information 201 is added and stored such that a scene to be newly recorded now belongs to a new program. Subsequently, at step 304, recording is started, and the date information entry guidance for the user to enter date information is automatically displayed on the display unit 107 to prompt the user to enter the date. Next, at step 305, date information entered by the user is stored in the program title information 202 as date information of the scene to be newly recorded and as information on the title of the new program to which the newly recorded scene belongs. Here, at steps 304 and 305, the recording is started without waiting for date information entered by the user in order to eliminate a time difference between the time at which a recording start instruction is issued by the user and the time at which the recording is actually started. At step 306, the date information entered by the user and time information starting from 0:00:00, automatically generated, are stored in the date and time information 204 of each scene. Then, at step 307, recording into the image data file 203 is stopped at the time the user issues a recording stop instruction, and an end time counted from 0:00:00 is stored in the date and time information 204 of each scene.

Here, if the user has not entered date information at the time the recording is stopped, date and time information of the date at which the recording was performed is read from the current date and time information holder unit 110 and stored in the date and time information 204 of each scene. Also, the date information is stored in the program title information 202 as information on the title of the new program to which the recorded scene belongs.

Next, the flow of processing will be described with reference to FIG. 4 which illustrates an exemplary flow chart of a recording processing procedure which is performed when the video camera 100 is in the camera input mode, as determined at step 302 in FIG. 3.

First at step 402, the date and time information 204 of each of recorded scenes is read to identify the date of the most recent scene. Also, the current date and time information, held in the current date and time information holder unit 110 of the video camera 100, is read for comparison with the date of the most recent scene at step 403. When the both dates are the same at step 403, the program range information 201 is modified at step 404 such that a scene to be newly recorded hereafter belongs to a program to which the scene presenting the most recent date belongs. Subsequently, the current date and time information is stored in the date and time information 204 of the scene to be newly recorded, and the recording is started at step 409. If both the dates are different at step 403, the program range information 201 is additionally stored such that a newly recorded scene belongs to a new program at step 406. Also, at step 407, date and time information held in the current date and time information holder unit 110 of the video camera 100 is read, the current date is stored in the program title information 202 of the newly created program, and the current date and time information is stored in the date and time information 204 of each scene at step 408. Then, the recording is started at step 409. Subsequently, at the time the user issues a recording stop instruction, the recording into the image data file 203 is terminated, and the current time information at the end of the recording is stored in the date and time information 204 of each scene.

In this embodiment, the date information of recorded scenes is read from the date and time information 204 of each scene for comparison at step 403, but the date information may be read from the program title information 202.

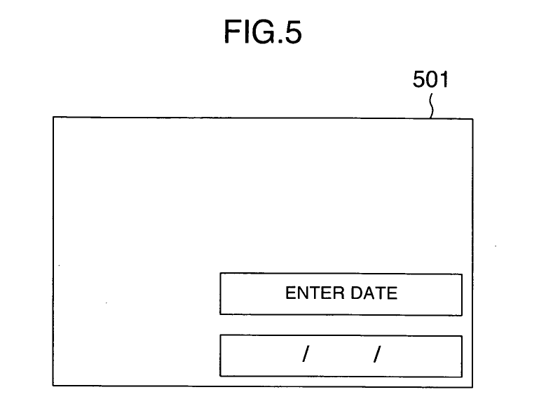

Next, FIG. 5 illustrates an exemplary screen which automatically displays the date information entry guidance for the user to enter date information to prompt the user to enter the date at step 304 in FIG. 3. As a recording start instruction is issued in the external input mode, the recording is started, and a date entry screen as 501 is displayed on the display unit 107 to prompt the user to enter the date. As the user enters the date in a lower right field of the screen, the entered date information is stored in the program title information 202 of the program to which a newly recorded scene belongs.

In the foregoing manner, in the video camera 100 of this embodiment which automatically records image data in groups according to the date, a step is provided for detecting the source of image data when the recording is started. In the external input mode, image data from the external input terminal is recorded in a different group. In this way, even if the user records image data captured by the video camera 100 and dubs an analog image which does not have date and time information as to when the analog image was captured in the past, on the same day as the recording, a scene recorded by the dubbing can be automatically managed in an independent program. Also, the date information entry guidance for the user to enter date information is automatically displayed on the display unit to prompt the user to enter the date, and the entered date information is stored in the program title information of the program to which the scene belongs, and in the date and time information of the scene. In this way, when image data is dubbed, it is possible to reduce the operational burden on the user for changing the date of image data after the dubbing to the date at which the original analog image data was recorded.

It should be understood that the present invention is not limited to the foregoing embodiment, but can be practiced in a variety of forms. For example, while the camera integrated recorder is exemplified by a DVD recording camera in the foregoing embodiment, the recording medium is not limited to the DVD, but the present invention can also be applied to a camera integrated recorder which uses another recording medium such as a tape. Also, a recording medium may be either incorporated, or external or removable.

Also, while the foregoing embodiment has been described for the dubbing of analog image data, when original image data is digitally recorded, date and time information may be automatically extracted from the original digital image data and recorded together with the image data.

Further, when recording is started in the external input mode, the user may be allowed to select, through a menu or the like, whether or not a new program is automatically created.

In addition, when respective groups of image data are displayed on the display unit, sources may be displayed in graphic representation, permitting the user to visually know the sources, so that the search is further facilitated.

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications a fall within the ambit of the appended claims.

1. An image management method of recording image data together with date information indicative of a date at which the image data was recorded on a predetermined recording medium to manage the image data in date-based groups based on the date information, said method comprising the steps of:
inputting image data from a plurality of image sources;
detecting an image source of each of the inputted image data; and
when image data from a first image source and image data from a second image source are recorded on the same day, managing the image data from said first image source in a first group based on date information indicative of a current recording date, and managing the image data from said second image source in a second group different from the first group.

2. An image management method according to claim 1, further comprising the steps of:
when image data from said second image source is recorded, entering date information indicative of the recorded date; and
recording the date information entered at the preceding step together with the image data as date information indicative of the recorded date.

3. A video camera which employs the image management method according to claim 2, wherein:
the image data from said first image source is image data from an image pickup device; and
the image data from said second image source is image data from an external input terminal.

4. An image management apparatus which records image data together with date information indicative of a date at which the image data was recorded on a predetermined recording medium to manage the image data in date-based groups based on the date information, said apparatus comprising:
an input module which receives image data from a plurality of image sources; and
a detector module which detects an image source of each of the inputted image data,
wherein when image data from a first image source and image data from a second image source are recorded on the same day, said image management apparatus manages the image data from said first image source in a first group based on date information indicative of a current recording date, and manages the image data from said second image source in a second group different from the first group.

5. An image management apparatus according to claim 4, further comprising:
a date information entering module which receives date information indicative of the recorded date when image data from said second image source is recorded,
wherein said image management apparatus records the date information entered through the date information entering module together with the image data as date information indicative of the recorded date.

6. A video camera which employs the image management apparatus according to claim 5, wherein:
the image data from said first image source is image data from an image pickup device; and
the image data from said second image source is image data from an external input terminal.

7. A recording apparatus for receiving image data from a plurality of image sources to record the image data together with date information associated with the image data, said apparatus comprising:
a detector module which detects the image source; and
a current date information holder module which holds current date information,
wherein said recording apparatus, based on a detection made by said detector module, corresponds date information from said current date information holder module to image data from a first image source, and corresponds date information different from the date information from said current date information holder module to image data from a second image source.

8. A recording apparatus according to claim 7, wherein said recording apparatus groups the image data from said first image source according to the date based on the date information from said current date information holder module.

9. A recording apparatus according to claim 8, further comprising:
an output module which outputs a screen on a display module for instructing a user to enter date information; and
a user control module which is operated by the user to enter the date information in response to the instruction,
wherein said recording apparatus corresponds the date information entered by the user through said user control module to the image data from said second image source.

10. A recording apparatus according to claim 9, further comprising:
a camera module which converts an optical image to a video signal to capture image data; and
an external input module which captures image data from an external device,
wherein said first image source is said camera module, and
said second image source is said external input module.
